(19) United States
(12) Patent Application Publication
(10) Pub. No.: US 2007/0086505 A1
(43) Pub. Date: Apr. 19, 2007

(54) Disposable temperature tape

(76) Inventor: James G. Linsenbigler, Ebensburg, PA (US)

Correspondence Address: JAMES RAY & ASSOCIATES, 2640 Pitcairn Road, Monroeville, PA, 15146, US

(21) Appl. No.: 11/251,336

(22) Filed: Oct. 14, 2005

(51) Int. Cl. G01K 3/00

(52) U.S. Cl. 374/104

(57) ABSTRACT

An apparatus for use with measuring a peak temperature at which refrigerated food products have been exposed. The apparatus comprises a pair of members, each of the pair of members having a predetermined shape, at least one of the pair of members being a transparent plastic. There is a means disposed between the pair of members for measuring a peak temperature to which such refrigerated food product has been exposed and a sealing means is disposed adjacent and between an outer perimeter of the pair of members for sealing the of members with the means for measuring peak temperature disposed therein.

### FIELD OF THE INVENTION

The present invention relates, in general, to an aid for measuring a peak temperature in an article of food and, more, particularly, the present invention relates to a temperature sensing tape which will record the highest temperature reached in that article of food so as to determine at what temperature that product was subjected.

### BACKGROUND OF THE INVENTION

In everyday life many food products are stored at refrigerated or even frozen temperatures. These products may remain in either the refrigerator or the freezer for an extended period of time. The user assumes that the product is safe. However, there are periods when there are power failures in which the user is never sure how warm the interior of the appliance has reached and more importantly at what temperature the food has been subjected. The same can be true in the store or packaging plant where the food product was made or prepared.

There are government or industry regulations which require that food in freezers be maintained at given temperatures and food in refrigerators at a given temperature. For example, frozen food and ice cream should be maintained at +10° and below, while dairy and deli foods should be maintained at 38° and below in order that the food is maintained safely.

Thus, it would be useful to the companies and consumers dealing with these products if one were able to ascertain what is the peak or highest temperature to which the food has been exposed so as to be sure that such foods were not exposed to temperatures higher than necessary to keep the foods safe.

### SUMMARY OF THE INVENTION

The present invention provides an apparatus for use with measuring a peak temperature at which a refrigerated food product has been exposed. The apparatus comprises a pair of members, each of the pair of members having a predetermined shape, at least a portion of at least one of the pair of members being a transparent plastic. There is a means disposed between the pair of members for measuring a peak temperature to which such refrigerated food product has been exposed and a sealing means is disposed adjacent and between an outer perimeter of the pair of members for sealing the of members with the means for measuring peak temperature disposed therein.

Another embodiment of the invention provides a method for ensuring that refrigerated food products have not been exposed to an excessively high temperature prior to such food being used. The method comprising the steps of disposing a preselected temperature measuring means one of secured to an outer surface of a package containing the refrigerated food product and within such package. There is a step of reading the peak temperature at an appropriate time and a step of determining if the food product has been exposed to an excessive temperature.

Yet another embodiment of the invention provides in combination with a refrigeration unit an apparatus for use therein for measuring a peak temperature that such refrigerated food products have been exposed. The apparatus comprises a pair of members, each of the pair of members having a predetermined shape, at least a portion of at least one of the pair of members being a transparent plastic. There is a means disposed between the pair of members for measuring a peak temperature to which such refrigerated food product has been exposed and a sealing means disposed adjacent and between an outer perimeter of the pair of members for sealing the pair of members with the means for measuring peak temperature disposed therein.

### OBJECTS OF THE INVENTION

It is, therefore, one of the primary objects of the present invention is to provide a temperature tape for furnishing a permanent record of maximum temperatures reached by the object to which the tape has been applied.

Another object of the present invention is to provide a temperature tape which is disposable after it has been used.

Still, another object of the present invention is to provide a temperature tape which can be used for food products.

Yet, another object of the present invention is to provide a temperature tape wherein the tape is plastic.

Another object of the present invention is to provide a temperature tape which is clear or transparent at least on one side so such maximum temperature can be read easily.

It is another object of the present invention to provide a temperature tape that has chemicals disposed therein which will change color with a change in temperature.

In addition to the numerous objects and advantages of the present invention which have been described with some degree of particularity above, it should be both noted and understood that a number of other important objects and advantages of the invention will become more readily apparent to those persons who are skilled in the relevant art from the following more detailed description of the invention, particularly, when such detailed description is taken in conjunction with the appended claims.

### BRIEF DESCRIPTION OF THE DRAWINGS

FIG. 1 is a top view of the apparatus according to an embodiment of the invention.

FIG. 2 is a side view of the apparatus shown in FIG. 1.

FIG. 3 is a top view of the invention according to alternate embodiment of the invention.

FIG. 4 is a side view of the apparatus show in FIG. 3.

### BRIEF DESCRIPTION OF THE PRESENTLY PREFERRED AND VARIOUS ALTERNATE EMBODIMENTS OF THE PRESENT INVENTION

Prior to proceeding to the more detailed description of the present invention, it should be noted that for the sake of clarity in understanding the invention, identical components with identical functions have been designated with identical reference numerals throughout the drawing Figures.

The present invention provides a temperature measuring device (apparatus), generally designated 10, comprising a plastic strip which can be either flexible or rigid, although it is presently preferred that such strip is flexible. Having encapsulated therein or disposed therein is a temperature responsive chemical, liquid crystal or other such material responsive to temperature changes. Such temperature responsive material is responsive in the temperature range of interest. This range of interest would be dependent upon whether such food stuff being monitored requires normal refrigeration or must be kept frozen.

Illustrated in the drawing FIGS. 3 and 4 is an apparatus 10 according to one embodiment of the invention. In this embodiment the apparatus 10 is for use in measuring a peak temperature at which refrigerated food products have been exposed. The apparatus 10 comprises a pair of members 2,4, each of the pair of members 2,4 having a predetermined shape, at least one of the pair of members being a transparent plastic. There is a means, generally designated 20, disposed between the pair of members 2,4 for measuring a peak temperature to which such refrigerated food product has been exposed and a sealing means, generally designated 30, is disposed adjacent and between an outer perimeter of the pair of members 2,4 for sealing the pair of members 2,4 with the means 20 for measuring peak temperature disposed therein. It is preferred that such sealing means 30 is an adhesive.

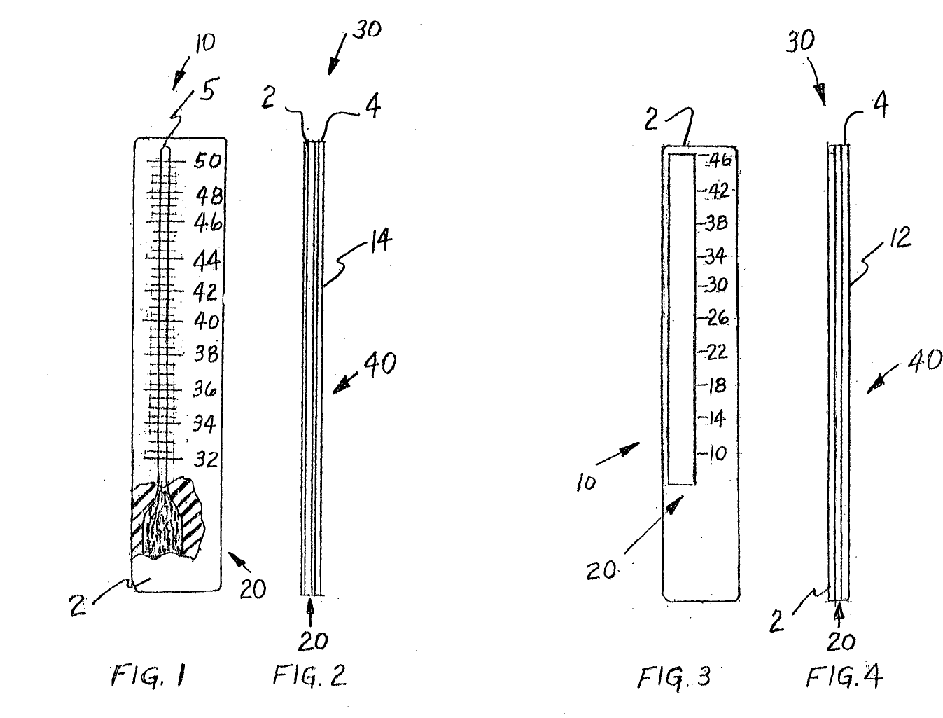

In another embodiment of the invention illustrated in FIGS. 1 and 2 the apparatus 10 contains such means for measuring temperature 20 that is something similar to a capillary thermometer wherein the temperature measuring material 20 travels up a generally flat tube 5 disposed within a pair of members 2,4 and records a maximum temperature.

The apparatus 10 further includes a securing means, generally designated 40, disposed on at least a portion of an outer surface of one of the pair of members 2,4 which will be disposed adjacent a package containing such food product during use of the apparatus 10 for securing the apparatus 10 to an outer surface of such package. Such securing means 40 is selected from one of adhesive 12 and double sided tape 14. It is presently preferred that such securing means 40 is double sided tape 14.

It is also presently preferred that such apparatus 10 is disposable. It is also presently preferred that each of the pair of members 2,4 are made of plastic; however, it is only necessary that one of the members be made be a transparent plastic so that the temperature may be read.

Another embodiment of the invention provides a method for ensuring that refrigerated food products have not been exposed to an excessively high temperature prior to such food being used. The method comprising the steps of disposing a preselected temperature measuring means one of secured to an outer surface of a package containing the refrigerated food product and within such package. There is a step of reading the peak temperature at an appropriate time and a step of determining if the food product has been exposed to an excessive temperature.

Yet another embodiment of the invention provides in combination with a refrigeration unit, not shown, an apparatus for use with such refrigerated products stored therein for measuring a peak temperature that such refrigerated food products have been exposed. The apparatus 10 comprises a pair of members 2,4, each of the pair of members 2,4 having a predetermined shape. At least one of the pair of members 2,4 being a transparent plastic. There is a means 20 disposed between the pair of members for measuring a peak temperature to which such refrigerated food product has been exposed and a sealing means 30 disposed adjacent and between an outer perimeter of the pair of members 2,4 for sealing the pair of members 2,4 with the means 20 for measuring peak temperature disposed therein.

While a presently preferred embodiment and alternate embodiments of the present invention have been described in detail above, it should be understood that various other adaptations and/or modifications of the invention can be made by those persons who are particularly skilled in the art without departing from either the spirit of the invention or the scope of the appended claims.

I claim:

1. An apparatus for use with measuring a peak temperature at which a refrigerated food product has been exposed, said apparatus comprising:
(a) a pair of members, each of said pair of members having a predetermined shape, at least a portion of at least one of said pair of members being transparent plastic;
(b) a means disposed between said pair of members for measuring a peak temperature to which such refrigerated food product has been exposed; and
(c) a sealing means disposed adjacent and between an outer perimeter of said pair of members for sealing said pair of members with said means for measuring peak temperature disposed therein.

2. The apparatus, according to claim 1, wherein said apparatus further includes a securing means disposed on at least a portion of an outer surface of one of said pair of members which will be disposed adjacent a package containing such food product during use of said apparatus for securing said apparatus to an outer surface of such package.

3. The apparatus, according to claim 2, wherein said securing means is selected from one of adhesive and double sided tape.

4. The apparatus, according to claim 3, wherein said securing means is double sided tape.

5. The apparatus, according to claim 1, wherein said apparatus is disposable.

6. The apparatus, according to claim 1, wherein both of said pair of members are plastic.

7. The apparatus, according to claim 1, wherein said apparatus is in a form of a tape.

8. The apparatus, according to claim 7, wherein said tape is flexible.

9. The apparatus, according to claim 1, wherein said sealing means is an adhesive.

10. A method for ensuring that refrigerated food products have not been exposed to an excessively high temperature prior to using said food products, said method comprising the steps of:
(a) disposing a preselected temperature measuring means one of secured to an outer surface of a package containing said refrigerated food product and within said package;
(b) reading said peak temperature at an appropriate time; and
(c) determining if said food product has been exposed to said excessive temperature.

11. The method, according to claim 10, wherein said method includes the step of securing said measuring means to an outer surface of a package containing said refrigerated food product and within said package.

12. The method, according to claim 11, wherein said step of securing said measuring means to an outer surface of a package containing said refrigerated food product and within said package further includes the step of applying double faced tape to said securing means.

13. The method, according to claim 12, wherein said step of securing said measuring means to an outer surface of a package containing said refrigerated food product and within said package further includes the step of attaching said securing means to said package containing said food product by means of said double faced tape applied to said securing means in a previous step.

14. The method, according to claim 10, wherein said method includes the step of disposing of said refrigerated food product when it has been has been determined said food product has been exposed to said excessive temperature.

15. The method, according to claim 10, wherein said method includes the step of disposing of said measuring means after said measuring means has recorded an excessive temperature.

16. In combination with a refrigeration unit an apparatus for use therein for measuring a peak temperature that refrigerated food products have been exposed, said apparatus comprising:
(a) a pair of members, each of said pair of members having a predetermined shape, at least a portion of at least one of said pair of members being a transparent plastic;
(b) a means disposed between said pair of members for measuring a peak temperature to which such refrigerated food product has been exposed; and
(c) a sealing means disposed adjacent and between an outer perimeter of said pair of members for sealing said pair of members with said means for measuring peak temperature disposed therein.

17. The combination, according to claim 16, wherein said apparatus further includes a means disposed on at least a portion of an outer surface of one of said pair of members which will be disposed one of adjacent such food product and within said refrigeration unit during use of said apparatus.

18. The combination, according to claim 16, wherein said apparatus is disposable.

19. The combination, according to claim 16, wherein said refrigeration unit further includes a timing means for determining if said refrigeration unit has been without power.
